(19) United States
(12) Patent Application Publication
(10) Pub. No.: US 2026/0017652 A1
(43) Pub. Date: Jan. 15, 2026

(54) System and Method for Locating, Supporting, and Ensuring the Safety of Local Vendors through a Mobile Application Platform

(71) Applicant: Lino Lares, Las Vegas, NV (US)

(72) Inventor: Lino Lares, Las Vegas, NV (US)

(21) Appl. No.: 18/771,550

(22) Filed: Jul. 12, 2024

(51) Int. Cl. G06Q 20/40; G06Q 50/26

(52) U.S. Cl. CPC G06Q 20/401; G06Q 50/265

(57) ABSTRACT

System disclosed herein aims to provide users with an easy way to locate and support local vendors like taco trucks and tamale vendors. For a monthly fee, vendors can register and list their locations on an interactive map, making them easily accessible to users. The app includes a distress button that vendors and users can activate in emergencies to alert nearby app users and authorities. Core features include user registration with email verification, vendor registration with detailed business information, a searchable map interface for locating vendors, and an emergency alert system. Additionally, the app offers a sponsorship section where users can support their favorite vendors through yearly subscriptions and donations via a secure payment gateway. The professional and business-oriented homepage prominently displays the app's logo and name, enhancing brand recognition. Overall, Vendor Finder improves local vendor visibility, community safety, and user engagement.

### BACKGROUND

### Field of the Invention

Embodiments relate to the field of communications, Mobile Application Development, Geographic Information Systems (GIS), and Community Safety and, more particularly, to a system and a method for that leverages on modern mobile technology to connect users with local vendors, enhancing community engagement and local commerce. It utilizes advanced mapping and geolocation features to provide real-time vendor locations and incorporates safety features such as a distress button, emphasizing community support and emergency responsiveness.

### Description of the Related Art

The food industry has seen a significant transformation in recent years, with local vendors, such as taco trucks and tamale vendors, gaining immense popularity. These vendors provide unique and authentic culinary experiences that are cherished by communities. However, despite their popularity, local vendors face numerous challenges, including visibility, safety, and financial support. To address these issues, we have developed the Vendor Finder app, a comprehensive mobile application platform designed to enhance the discovery, support, and protection of local vendors. This innovative system integrates user and vendor registration, a searchable map interface, an emergency distress notification system, and a sponsorship and donation platform, providing a holistic solution tailored to the needs of local vendors and their communities.

Local vendors are a vital part of the economy, contributing to the vibrancy and diversity of the food industry. They offer unique culinary experiences that often cannot be found in traditional brick-and-mortar restaurants. These vendors also play a crucial role in job creation and community building, often serving as gathering spots for social interactions. Enhancing their visibility and ensuring their safety are essential for their sustainability and growth. By providing a dedicated platform for local vendors, we can help them reach a broader audience, improve their operational efficiency, and foster a supportive community environment. The Vendor Finder app aims to bridge the gap between vendors and customers, creating a more robust and interconnected ecosystem for local businesses,

The significance of local vendors in the economy is underscored by various statistics. According to the U.S. Small Business Administration, small businesses, including food trucks and street vendors, contribute 44% of U.S. economic activity. The food truck industry alone has experienced a remarkable growth rate, with an annual increase of 7.5% from 2015 to 2020. By 2020, the industry's revenue exceeded $1.2 billion. Despite this growth, local vendors continue to face challenges related to visibility and safety. A survey conducted by the National Food Truck Association revealed that 65% of food truck operators identified location visibility as a significant challenge, while 48% expressed concerns about safety, particularly when operating in isolated areas. These statistics highlight the need for innovative solutions that address these issues and support the thriving local vendor industry.

Various platforms and applications have attempted to address the needs of local vendors, but none have provided a comprehensive solution tailored to their unique requirements. For instance, platforms like Yelp and Google Maps offer general visibility for businesses, including local vendors. These platforms allow users to search for nearby businesses and read reviews, providing some level of visibility for vendors. Similarly, food delivery apps like Uber Eats and DoorDash have included features for food trucks and street vendors, allowing them to reach a broader customer base. However, these platforms primarily focus on broader business categories and lack specialized features that cater to the specific needs of local vendors, such as real-time location tracking and emergency notification systems.

By looking at prior art multiple advancements have been seen in prior art. For instance, a U.S. Pat. No. 2,015,0178778A1 relates to Location-based triggered delivery system. The system and method for a location-based triggered delivery are described. A location of a device of a user is determined. A condition for delivering an item at a delivery location is identified. The condition is trigged when the location of the device of the user crosses a geographic boundary for the device of the user. An estimated arrival time of the user to the delivery location is calculated. A courier available to deliver the item at the delivery location at the estimated arrival time is calculated. The courier is dispatched when the condition is triggered.

A U.S. Pat. No. 2,003,0004743A1 relates to methods for providing a location based merchant presence. The Methods and systems for providing a merchant presence to a consumer based on the respective locations of the consumer and the merchant are disclosed. The methods include determining the location of the consumer by receiving an indication of the consumer's location from a consumer device and transmitting an electronic message regarding the merchant's presence to the consumer device only if the indicated location of the consumer is the same as, overlaps with, or comes within a service area, that defines the location of the merchant. The merchant's presence is actively “pushed” to the consumer based on detecting the consumer's location without need of the consumer to conduct an active search for the merchant. The consumer's location may be continuously tracked using geo positioning coordinates and the merchant presence is updated based on the consumer's changing locations. The merchant presence is transmitted in any of a variety of format compatible with the consumer device.

Despite the availability of these platforms, local vendors still face significant challenges that have not been adequately addressed. Visibility remains a major issue, as many vendors do not have a permanent location and rely heavily on foot traffic for their business. This makes it difficult for customers to locate them, especially when they change locations frequently. Safety concerns are also prevalent, with vendors often operating in isolated areas without quick access to emergency services. Additionally, there is a lack of platforms that facilitate direct community support through sponsorship and donations, leaving vendors without crucial financial backing. These gaps highlight the need for a dedicated platform that provides comprehensive solutions to enhance the visibility, safety, and support of local vendors.

The proposed system is designed to address these gaps by providing a dedicated platform for local vendors. This system integrates user and vendor registration, a searchable map interface, an emergency distress notification system, and a sponsorship and donation section. The app allows vendors to create a profile, list their business, and provide essential information such as business name, location, contact details, and vendor type. Users can search for specific vendors or types of vendors using keywords or categories, and the app displays a map with pins marking the locations of the searched vendors. The emergency distress notification system is a vital safety feature that allows vendors to send real-time alerts to nearby app users and local authorities in case of emergencies. The sponsorship and donation platform enables users to support their favorite vendors financially by paying for their yearly subscription or making a one-time donation. This comprehensive solution is tailored to the unique needs of local vendors, enhancing their visibility, ensuring their safety, and fostering community support.

The proposed system is a comprehensive solution designed to address the unique challenges faced by local vendors. By enhancing visibility through a searchable map interface, ensuring safety with an emergency distress notification system, and fostering community support through a sponsorship and donation platform, the app provides a holistic approach to supporting local vendors. This innovative platform not only benefits the vendors but also strengthens the community by promoting local businesses and fostering a culture of support and safety. With its user-friendly design, robust security features, and modular architecture, the Vendor Finder app is poised to revolutionize the way local vendors operate and interact with their customers, ensuring their sustainability and growth in the competitive food industry.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is therefore the purpose of the invention to alleviate at least to some extent one or more of the aforementioned problems of the prior art and/or to provide the relevant public with a suitable alternative thereto having relative advantages.

The primary object of the invention is related to the provision of a technologically enhanced system and method for locating, supporting, and ensuring the safety of local vendors through a mobile application platform

It is also the objective of the invention to provide an advanced approach to facilitate the visibility and accessibility of local vendors by providing a comprehensive platform that allows users to easily locate and support vendors through a searchable map interface.

It is further the objective of the invention to improve user safety by integrating an emergency distress notification system that alerts nearby users and authorities in real-time when a vendor or user is in distress, providing their exact location.

It is also the objective of the invention to ensure secure and efficient user and vendor registration processes by incorporating email validation, OTP verification, and secure payment gateways for subscription management.

It is moreover the objective of the invention to facilitate community support for local vendors through a sponsorship and donation platform, allowing users to sponsor vendors' yearly subscriptions or make one-time donations with secure transactions.

It is also the objective of the invention to enhance the user experience by offering an intuitive and responsive interface design that includes advanced search filters, zoom and pan functionality, and detailed vendor profiles with user reviews.

It is also the objective of the invention to provide vendors with tools to manage their business presence on the app, including subscription management, profile updates, and the ability to offer rewards or incentives to sponsors.

Another objective of the present invention is to ensure the scalability and reliability of the platform through a robust backend infrastructure that includes load balancing, secure database management, and integration with third-party services.

It is further the objective of the invention to protect user and vendor data through the use of SSL encryption, secure password hashing, and regular security audits, ensuring the confidentiality and integrity of sensitive information.

It is further the objective of the system to support continuous improvement and adaptability by designing the system with modular architecture, allowing for easy updates and the integration of new features as needed.

It is moreover the objective of the system to foster community engagement and support by providing features that allow users to share their sponsorship activities on social media and track the impact of their donations, encouraging others to support local vendors.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current invention in its preferred embodiment discloses an advanced system designed to help users locate and support local vendors, such as taco trucks and tamale vendors, by providing a comprehensive platform that integrates user and vendor registration, a searchable map interface, an emergency distress notification system, and a sponsorship and donation section. The app aims to enhance the visibility of local vendors while offering safety features and opportunities for community support. The primary components of the app include hardware and software modules that work together to deliver a seamless user experience.

The hardware components necessary for the Vendor Finder app include mobile devices (smartphones and tablets) used by both vendors and users. These devices must support GPS functionality to provide real-time location services, and they should have internet connectivity (Wi-Fi or cellular) to enable communication with the app's servers. Additionally, server hardware is required to host the backend infrastructure, manage user data, and handle transactions securely. The server setup should include load balancers, database servers, and web servers to ensure high availability and reliability.

The invention is based on components of an exemplary environment in which the invention may be used. The online system has focused components and is based on simple to use. The software can be viewed and used from a smart devices. In order to use the application, the user has to be connected to the internet to use the services in real-time. The real-time utility needs to be connected to the internet through local area networks (“LANs”)/wide area networks (“WANs”), wireless networks, or independent internet sources. Further, the internet would connect the user to the online application server, through the user's computing or mobile device, where applicable.

Generally, the user device may include virtually any computing device capable of receiving and sending a message over a network, such as LAN/WAN or independent network, wireless network, and the like, to and from another computing device, such as a server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smartphones, Tablets or PDAs. Similarly, the client device may be any device that is capable of connecting using a wired or wireless communication medium such as a PDA, POCKET PC, wearable computer, and any other device that is equipped to communicate over a wired and/or wireless communication medium.

The user's device may include a browser application that is configured to receive and to send web pages, web-based messages, and the like. The browser application may be configured to receive and display graphics, text, multimedia, and the like, employing virtually any web-based language, including Standard Generalized Markup Language (SMGL), HyperText Markup Language (HTML), and so forth.

The system is designed to have two ends. One is the front end which is designed as the front panel with GUI for taking the user's input and displaying various types of outputs and the second one is the back end which is the cloud-based server. All information entered is stored, processed and evaluated in the database server according to the given format. The same database allows successful evaluation and withdrawal of information.

As per its preferred embodiments, the system involves a user registration and login module is a critical software component that ensures secure access to the app. Users must create an account using a verified email address and password. The registration process includes email validation to check the format of the input and sends a One-Time Password (OTP) to the user's email for verification. This module uses secure hashing algorithms to store passwords and employs SSL encryption to protect data during transmission. Once verified, users can log in and access the app's features.

As per its further embodiments, the vendor registration and subscription module allows the vendors to create an account and list their business on the app by paying a monthly subscription fee. Vendors must provide essential information such as business name, location, contact details, and vendor type. Upon successful registration, vendors receive a confirmation email. This module integrates with payment gateways to handle subscription fees securely and provides vendors with an interface to manage their profile and subscription details. The module also supports automated email notifications for subscription renewals and updates.

As per its preferred embodiments, the vendor search and map display module enables users to find specific vendors or types of vendors using keywords or categories. The app displays a map with pins marking the locations of the searched vendors, and the interface includes zoom and pan functionality for improved user experience. This module relies on GPS data from user devices and integrates with mapping services (such as Google Maps) to provide accurate location information. Users can click on vendor pins to view detailed profiles, including business hours, contact information, and user reviews.

As per its preferred embodiments, the emergency distress notification system is a vital safety feature for vendors and users. This module includes a distress button that, when activated, sends real-time alerts to nearby app users and local authorities with the vendor's or user's location and contact details. The module uses geolocation services to pinpoint the exact coordinates and sends notifications through push notifications and SMS. Nearby users receive the distress alert with options to respond or navigate to the location to provide assistance. This system also includes an alert history log for tracking past emergencies.

As per its preferred embodiments, the sponsorship and donation platform allows users to support their favorite vendors by paying for their yearly subscription or making a one-time donation. This module includes a secure payment gateway that uses encryption to protect transaction data. Users can view vendor sponsorship profiles, detailing their needs and goals, and track the impact of their donations through updates provided by the vendors. The module supports recurring payments, automated receipts, and rewards or incentives for sponsors, such as discounts or special offers from the vendors.

As per its preferred embodiments, the user experience (UX) and interface design of the Vendor Finder app focus on ease of use and professional aesthetics. The homepage features a prominent display of the app's logo and name, enhancing brand recognition. The interface is designed to be intuitive, with clear navigation paths for user registration, vendor search, distress button access, and sponsorship activities. The design includes responsive elements to ensure a seamless experience across different devices and screen sizes. Feedback from users is continuously incorporated to refine the UX.

As per its preferred embodiments, the backend infrastructure of the Vendor Finder app includes server-side software that manages user data, processes payments, and handles communication between modules. This infrastructure relies on robust database management systems (DBMS) to store user profiles, vendor information, transaction records, and distress alerts. Security is a top priority, with measures such as SSL encryption, secure password hashing, and regular security audits to protect sensitive data. The backend also includes load balancing and failover mechanisms to ensure high availability and reliability.

As per its preferred embodiments, the Vendor Finder app is designed with integration and scalability in mind. The app can integrate with third-party services, such as mapping APIs (e.g., Google Maps), payment gateways (e.g., Stripe), and SMS providers for distress alerts. This modular architecture allows for easy updates and the addition of new features. Scalability is achieved through cloud-based infrastructure, enabling the app to handle increasing numbers of users and vendors without compromising performance. Continuous monitoring and optimization ensure that the app can scale efficiently to meet growing demand.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter

We claim:

1. A system for locating and supporting local vendors, comprising:
A user registration module requiring email verification through OTP;
A vendor registration module with monthly subscription payment; and,
A searchable map interface displaying vendor locations.
The system of claim 1, wherein the user registration module includes an email validation process to ensure correct format input and prevent invalid email addresses and the user registration module sends a One-Time Password (OTP) to the user's email for verification before account creation is complete.
The system of claim 1, wherein the vendor registration module requires vendors to provide business name, location, contact details, and type of vendor during the registration process and the vendor registration module sends a confirmation email to vendors upon successful registration, including details of their subscription.
The system of claim 1, wherein the vendor registration module includes an interface for vendors to manage their subscription, update payment methods, and view payment history.
The system of claim 1, wherein the map interface includes advanced search filter options, allowing users to search for vendors based on location, category, or specific keywords.
The system of claim 1, wherein the map interface includes zoom and pan functionality to improve the user experience and allow users to navigate easily.
The system of claim 1, wherein the map interface displays detailed vendor profiles when a user selects a vendor pin, including vendor's business name, contact information, and hours of operation.
The system of claim 1, wherein the vendor profiles include a section for user reviews and ratings, allowing users to provide feedback on their experience with the vendor.

2. An emergency notification system for vendors and users, comprising:
A distress button for activating emergency alerts;
Notification to nearby app users and authorities with the vendor's location; and,
User response functionality to provide assistance.
The system of claim 2, wherein the distress button is available to non-vendor users for personal safety emergencies, allowing them to alert nearby app users and authorities and distress alert includes an automatic call or message to local authorities with the emergency details and location.
The system of claim 2, wherein the emergency alert is sent in real-time to authorities and nearby users, providing the vendor's or user's exact location and contact details.
The system of claim 2, wherein the distress button shares the exact GPS coordinates of the vendor or user in distress to the authorities and nearby app users.
The system of claim 2, wherein nearby users receive a notification with options to respond, such as calling the vendor, sending a message, or navigating to the vendor's location.
The system of claim 2, wherein vendors can add emergency contact information to their profile, which is included in the distress alert.
The system of claim 2, wherein vendors can customize their distress alert settings, such as adding a pre-recorded message or selecting specific contacts to be notified and the distress button is prominently displayed on the app's home screen for quick access in case of emergencies.
The system of claim 2, wherein the app maintains a log of all distress alerts sent, including date, time, and response details, accessible by the vendor or user.

3. A sponsorship and donation platform integrated within a vendor locator app, comprising:
A section for users to sponsor or donate to vendors;
Secure payment gateway for transactions; and,
Yearly subscription payment options for vendors.
The system of claim 3, wherein users can create a sponsorship profile detailing their needs and goals and can choose from multiple sponsorship options, such as monthly or yearly subscriptions, or one-time donations.
The system of claim 3, wherein the payment gateway uses encryption and secure transaction methods to protect user and vendor financial information and users can view their transaction history, including details of their sponsorships and donations, through their user profile.
The system of claim 3, wherein the app sends automated receipts to users after each sponsorship or donation transaction, including details of the amount and vendor supported.
The system of claim 3, wherein users can track the impact of their donations through updates provided by the vendors, visible on their sponsorship profile.
The system of claim 3, wherein vendors can offer rewards or incentives to users who sponsor them, such as discounts or special offer and users can leave feedback or reviews on their sponsorship experience, visible to other potential sponsors.
